(19) United States
(12) Patent Application Publication
(10) Pub. No.: US 2021/0021624 A1
(43) Pub. Date: Jan. 21, 2021

(54) METHOD, ELECTRONIC DEVICE AND COMPUTER PROGRAM PRODUCT FOR DETECTING ABNORMAL NETWORK REQUEST

(71) Applicant: EMC IP Holding Company LLC, Hopkinton, MA (US)

(72) Inventors: Fei Peng, Chengdu (CN); Mengjia Liang, Chengdu (CN); Yu Yan, Chengdu (CN)

(21) Appl. No.: 16/794,505

(22) Filed: Feb. 19, 2020

(30) Foreign Application Priority Data
Jul. 19, 2019 (CN) 201910656562.4

(51) Int. Cl. H04L 29/06; G06N 20/00

(52) U.S. Cl. CPC H04L 63/1425; G06N 20/00

(57) ABSTRACT

Embodiments of the present disclosure provide a method, an electronic device and a corresponding computer program product for detecting an abnormal network request. The method may include: obtaining a network request for accessing a server. The method may also include: extracting feature data from the network request. The feature data herein characterize an access operation of the network request to the server. The method further include; in response to the feature data falling out of a range defined by feature data of a plurality of normal network requests, determining the network request as an abnormal network request.

### CROSS-REFERENCE TO RELATED APPLICATIONS

This application claims benefit to Chinese Patent Application 201910656562.4 filed on Jul. 19, 2019. Chinese Patent Application 201910656562.4 is hereby incorporated by reference in its entirety.

### FIELD

The present disclosure generally relates to the field of computer network, and more specifically, to a method, electronic device and computer program product for detecting an abnormal network request.

### BACKGROUND

Nowadays, network security is becoming more and more important. For example, it is common to detect on the server side whether a received network request is a normal network request. However, it is difficult to to detect whether the network request is a normal network request initiated by a user or an abnormal network request initiated by a hacker. For example, in an http request the http header, cookie, and request body initiated by a hacker are similar to those initiated by a real user. If a network security engineer manually checks the network communication content between clients and the server, it will be found that some clients are not real users. However, manual checking by the engineers is inefficient and the feedback is typically slow.

### SUMMARY

The embodiments of the present disclosure provide a method, device and corresponding computer program product for detecting an abnormal network request.

In a first aspect of the present disclosure, there is provided a method for detecting an abnormal network request. The method may include: obtaining a network request for accessing a server. The method may also include: extracting feature data from the network request. The feature data herein characterizes an access operation of the network request to the server. The method may further include: in response to the feature data falling out of a range defined by feature data of a plurality of normal network requests, determining the network request as the abnormal network request.

In some embodiments, extracting the feature data from the network request may include: processing the network request with predetermined symbols; and obtaining the feature data from the processed network request.

In some embodiments, processing the network request with the predetermined symbols may include: replacing alphabets in the network request with a first symbol; and replacing numbers in the network request with a second symbol.

In some embodiments, processing the network request with the predetermined symbols may include: replacing an individual alphabet in the network request with a third symbol; replacing an individual number in the network request with a fourth symbol; replacing consecutive alphabets in the network request with a fifth symbol; and replacing consecutive numbers in the network request with a sixth symbol.

In some embodiments, extracting the feature data from the network request may further include: vectorizing the feature data.

In some embodiments, in response to the feature data falling out of the range defined by the feature data of the plurality of normal network requests, determining the network request as the abnormal network request may include: inputting the feature data of the network request into a classification model, the classification model being obtained by training the feature data of the plurality of normal network requests and being used to determine a boundary of the feature data of the plurality of normal network requests; and in response to the feature data of the network request being located outside the boundary, determining the network request as the abnormal network request.

In some embodiments, obtaining the network request for accessing the server may include: determining an Internet Protocol (IP) address of the network request; and obtaining, from the server, an associated network request having the IP address.

In some embodiments, extracting the feature data from the network request may include: converting Application Program Interface (API) information of the network request into a first API symbol; converting API information of the associated network request into a second API symbol; and combining the first API symbol and the second API symbol as at least a part of the feature data.

In some embodiments, in response to the feature data falling out of the range, determining the network request as the abnormal network request may include: determining a plurality of combinations of the plurality of normal network requests with API information of respective associated network requests; and in response to the at least a part of the feature data being absent in the plurality of combinations, determining the network request as the abnormal network request.

In some embodiments, the method may further include: sending the abnormal network request to a further server independent of the server, such that the further server generate a response to the abnormal network request, based on a type of the access operation of the abnormal network request.

In some embodiments, the access operation may include at least one of the following: Application Program Interface (API) information of the network request; parameters of the API information; address information of the server; a text length of the network request; and a request body of the network request.

In a second aspect of the present disclosure, there is provided an electronic device. The device may comprise: at least one processing unit; and at least one memory coupled to the at least one processing unit and storing machine-executable instructions, the instructions when executed by the at least one processing unit, causing the device to perform acts, the acts including: obtaining a network request for accessing a server; extracting feature data from the network request, the feature data characterizing an access operation of the network request to the server; and in response to the feature data falling out of a range defined by feature data of a plurality of normal network requests, determining the network request as an abnormal network request.

In a third aspect of the present disclosure, there is provided a computer program product tangibly stored on a non-transient computer readable medium and including machine executable instructions which, when executed, cause a machine to perform steps of the method according to the first aspect.

This Summary is provided to introduce a selection of concepts that are further described below in the Detailed Description in a simplified form. This Summary is not intended to identify key features or essential features of the claimed subject matter, nor is it intended to be used to limit the scope of the claimed subject matter.

### BRIEF DESCRIPTION OF THE DRAWINGS

The above and other objectives, features and advantages of the present disclosure will become more apparent, through the following detailed description of the example embodiments of the present disclosure with reference to the accompanying drawings, in which the same reference symbols generally refer to the same elements.

FIG. 1 illustrates a schematic diagram of an example environment in which a plurality of embodiments of the present disclosure may be implemented;

FIG. 2 illustrates a schematic diagram of a specific example environment in which a plurality of embodiments of the present disclosure may be implemented;

FIG. 3 illustrates a schematic diagram of a further specific example environment in which a plurality of embodiments of the present disclosure may be implemented;

FIG. 4 illustrates a flowchart of a process for detecting an abnormal network request according to embodiments of the present disclosure;

FIG. 5 illustrates a flowchart of a process for detecting an abnormal network request according to embodiments of the present disclosure; and

FIG. 6 illustrates a schematic block diagram of a computer device that may implement a plurality of embodiments of the present disclosure.

### DETAILED DESCRIPTION OF EMBODIMENTS

Preferred embodiments of the present disclosure will be described in greater detail with reference to the accompanying drawings. Although the drawings illustrate preferred embodiments of the present disclosure, it would be appreciated that the present disclosure may be implemented in various ways but should not be construed as being limited by the embodiments illustrated herein. Rather, these embodiments are provided to disclose the present disclosure more thoroughly and completely, and to convey the scope of the present disclosure fully to those skilled in the art.

As used herein, the term “includes” and its variants are to be read as open-ended terms that mean “includes, but is not limited to.” The term “or” is to be read as “and/or” unless the context clearly indicates otherwise. The term “based on” is to be read as “based at least in part on.” The term “an example embodiment” and “an embodiment” are to be read as “at least one example embodiment.” The term “another embodiment” is to be read as “at least another embodiment.” The terms “first,” “second,” and the like may refer to different or the same objects. Other definitions, either explicit or implicit, may be included below.

In order to detect network requests received on the server side, a firewall is often established. However, the new technologies for intrusion have been popping up all over the network. The traditional technology for web intrusion detection may block attacks, such as XS S, SQL injection, parameter manipulation, hidden field manipulation, and the like, but rules of these kinds of the technology for intrusion detection are typically not flexible enough for different kinds of attacks. Therefore, the new technologies for intrusion can bypass these rules easily. In addition, the new intrusion technologies also increase the cost of establishing and maintaining the rules.

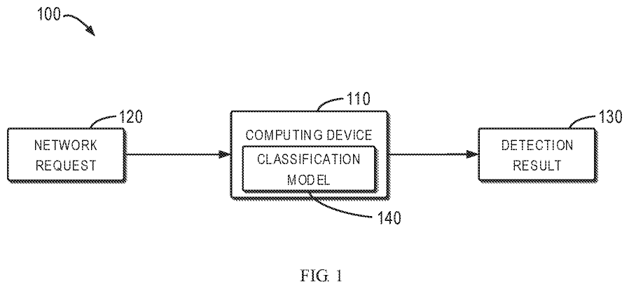

In order to at least partly address the above and other potential problems and deficiencies, the embodiments of the present disclosure propose a solution for detecting a network request. In various embodiments, a classification model may be trained through a plurality of normal network requests as a set of training data set, and then, the classification model may be used to determine whether the network requests input subsequently are similar to the normal network requests. Moreover, the present disclosure further provides a solution of multi-feature engineering for processing text of a network request, so as to allow the text to reflect an abnormal degree of the network request more easily. Further, the present disclosure may collect abnormal network requests and utilize a dedicated server to collect the abnormal network request. The dedicated server tricks the abnormal attacks by sending fake responses, so as to collect the abnormal network requests. Hence, embodiments of the present solution may detect abnormal network access operations accurately and efficiently, thereby improving the network environment. The various embodiments of the present disclosure will be discussed below with reference to FIG. 1.

FIG. 1 illustrates a schematic diagram of an example environment 100 in which a plurality of embodiments of the present disclosure may be implemented. As shown in FIG. 1, the environment 100 includes a computing device 110, a network request 120, and a detection result 130. In addition, the computing device 110 further includes a classification model 140. The network request 120 may be a network access request sent by a user via a client. Alternatively or additionally, the network request 120 may be a network attack initiated by a hacker. The computing device 110 may receive a network request 120 and determine the detection result 130 via the classification model 140 in the computing device 110. The detection result 130 may display whether the network request 120 is a normal network request from a user or an abnormal network request from a hacker.

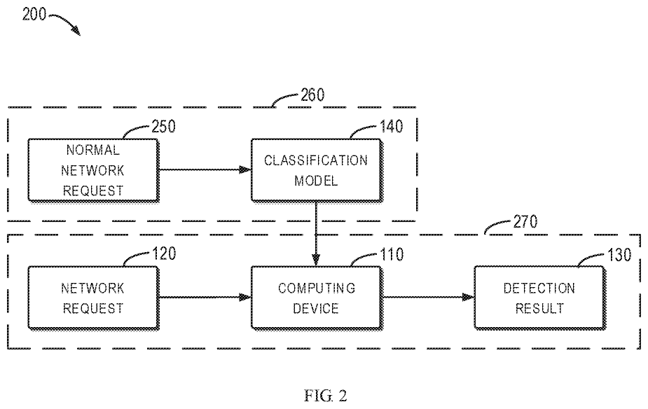

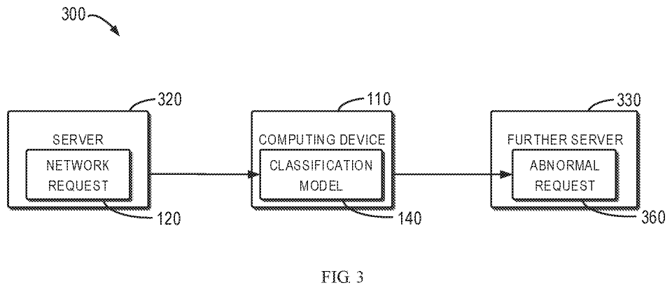

In FIG. 1, the generation of the detection result 130 is based on the various aspects. One aspect is that the classification model 140 in the computing device 110 is created through pre-training with a plurality of normal networks. Creating and utilizing of the classification model 140 will be described below with reference to FIG. 2. The other aspect is that the destination of the network request varies depending on the detection result 130. For example, if the detection result 130 indicates that the network request 120 is a normal network request, the network request 120 will be sent to a server that the user originally planned to access. If the detection result 130 indicates that the network request 120 is an abnormal network request, the network request 120 will be sent to a further server for collecting abnormal network requests. The processing of the abnormal network request will be described below with reference to FIG. 3.

FIG. 2 illustrates a schematic diagram of a specific example environment 200 in which a plurality of embodiments of the present disclosure may be implemented. Similar to FIG. 1, the example environment 200 may include a computing device 110, a network request 120, and a detection result 130. The difference lies in that the example environment 200 may generally include a model training system 260 and a model application system 270. As an example, the model training system 260 and/or model application system 270 may be implemented by the computing device 110 as shown in FIG. 1 or FIG. 2. It would be appreciated that the structure and functionality of the example environment 200 are described merely as an example, without suggesting any limitation to the scope of the subject matter as described herein. The subject matter as described herein may be implemented in different structures and/or functionalities.

As described above, the solution for detecting an abnormal network request according to the present disclosure may be divided into two phases: a model training phase and a model application phase. At the model training phase, the model training system 260 may train the classification model 140 for detecting an abnormal network request using a plurality of normal network requests 250. At the model application stage, the model application system 270 may receive the trained classification model 140 and the network request 120, so as to generate a detection result 130. In some embodiment, the normal network request 250 may be massive access requests from large number of uses.

Preferably, the classification model 140 may be a one class support vector machine (OCSVM). Through the training process, the respective parameters of the one class support vector machine can be determined. Since most of the network requests are normal network requests, samples of abnormal network requests are quite limited in number, or even the abnormal network request may occur initially. The one class vector machine may be trained through a plurality of normal network requests, to determine a decision boundary of the vector machine, and therefore the abnormal network request may be determined to be outside the boundary upon being receive. Therefore, the one class support vector machine may be suitable for the detection mechanism for an abnormal network request according to the present disclosure.

It would be appreciated that the classification model 140 may also be created as a learning network for detecting an abnormal network request. This learning network may also be referred to as learning model, or abbreviated as network or model. In some embodiments, a learning network for detecting an abnormal network request may include a plurality of networks, where each network may be a multi-layer neural network that may be comprised of a great number of neurons. Through the training process, the respective parameters of neurons in each network can be determined.

In the embodiments in which the classification model 140 is a learning network, the training process of the classification model 140 may be executed in an iterative fashion. More specifically, the model training system 260 may obtain a text of at least one normal network request from a plurality of normal network requests 250, and use the text to perform an iteration of the training process, so as to update the respective parameters of the classification model 140. The model training system 260 may repeat, based on the texts of the plurality of normal network requests 250, the above process until at least some of the parameters of the classification model 140 converge, so as to obtain the final model parameters. In addition, a standard back propagation neural network may execute iteration per sample. Moreover, there is still another method in which a total error of all samples is calculated in iteration, and then a weight matrix is updated.

FIG. 3 illustrates a schematic diagram of a further specific example environment 300 in which a plurality of embodiments of the present disclosure may be implemented. As shown in FIG. 3, the example environment 300 may include a server 320, a computing device 110, and a further server 330 independent from the server 320. Upon receiving a network request 120, the server 320 directly sends it to the computing device 110 for detection. The computing device 110 performs processing, such as feature engineering, on the network request 120, and further classifies the same via the classification model 140. If the classification model 140 determines that the network request 120 is an abnormal request 360, the computing device 110 sends the abnormal request 360 to the further server 330, such that the further server 330 can generate, based on the type of the access operation of the abnormal request 360, a response to the abnormal request 360.

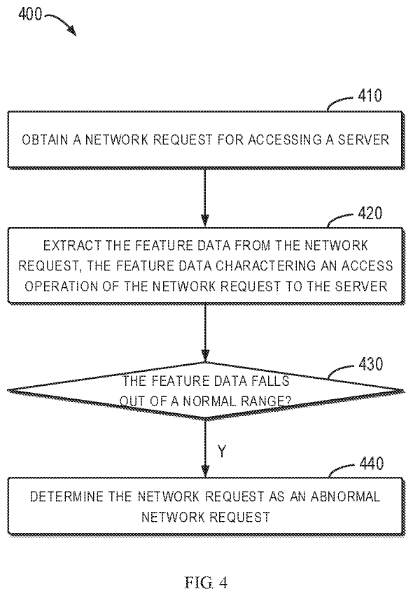

The embodiments described above are provided only as an example, rather than a limitation to the present disclosure. In order to clarify the principle of the above solution, the process of detecting an abnormal network will be described below in detail with reference to FIG. 4.

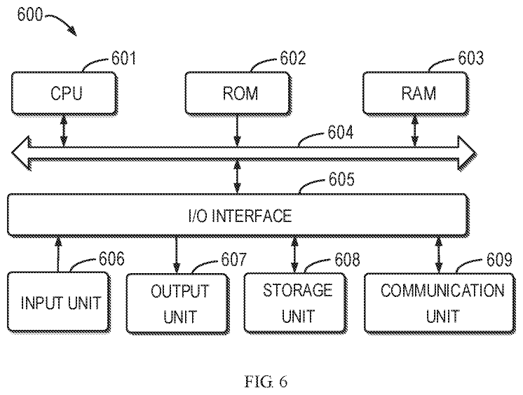

FIG. 4 illustrates a process or a method 400 for detecting an abnormal network request according to embodiments of the present disclosure. In some embodiments, the method 400 may be implemented in a device as shown in FIG. 6. For example, the method 400 may be implemented in the computing device 110 as shown in FIG. 1, FIG. 2, or FIG. 3. Reference will now be made to FIGS. 2 and 3 to describe the process or method 400 for detecting an abnormal network request according to the embodiments of the present disclosure. For ease of understanding, the specific data mentioned below are provided merely as an example, without suggesting any limitation to the protection scope of the present disclosure.

At 410, the computing device 110 obtains a network request 120 for accessing a server. For example, the computing device 110 may be disposed at the front side of the server similarly as the firewall does, for obtaining the network request 120 before the network request 120 arrives at the server and then detecting the same. Alternatively or additionally, as shown in FIG. 3, the computing device 110 may be disposed at the server side or within the server. Upon receiving the network request 120, the server 320 forwards it to the computing device 110, instead of processing it. If the computing device 110 determines that the network request 120 is a normal network request, the network request 120 is returned to the server 320 for processing.

In some embodiments, upon obtaining a network request 120 for accessing the server, the computing device 110 may determine the Internet Protocol (IP) address of the network request 120, and obtain from the server an associated network request having the IP address. For example, upon receiving a network request 120, the computing device 110 may first check the IP address of the network request 120 and the historical record under the IP address. If the historical record of the IP address is empty, the network request may be an abnormal network address (or may be a normal network request). More precisely, if a sequence comprised of the associated network request in the historical record of the IP address and the network request 120 is abnormal (for example, no network request “login” detected), the network request may be an abnormal network request. It would be appreciated that historical record query is performed to form an API context, so as to implement the feature engineering.

At 420, the computing device 110 may extract from the network request 120. The feature data characterizes an access operation of the network request 120 to the server. It would be appreciated that the access operation of the network request 120 to the server refers to removing from the text of the network request 120 the core of redundant information, which may include at least one of Application Program Interface (API) information of the network request 120, parameters of the API information, address information of the server, a text length of the network request 120, and a request body of the network request 120. The API information includes the API invoked by the network request 120 and its http method.

In some embodiments, the computing device 110 may process the network request 120 with predetermined symbols, and may obtain feature data via the processed network request. For example, since the APIs invoked by the network request 120 and the http methods are limited in number, they may be numbered serially. Therefore, if the API information in the received network request 120 is /api/v2/assetRules (i.e., API) and GET (i.e. the http method), the predetermined serial number may replace the API information in the network request 120, to simplify the network request 120. In addition, the following may be used to process the network request 120 using predetermined symbols.

In some embodiments, the computing device 110 may replace an individual alphabet in the network request 120 with a third symbol, an individual number in the network request 120 with a fourth symbol, consecutive alphabets in the network request 120 with a fifth symbol, and consecutive numbers in the network request 120 with a sixth symbol.

For example, the computing device 110 may replace the alphabets in the network request 120 with a first symbol, and the numbers in the network request 120 with a second symbol. It would be appreciated that all replacement manners are applicable to all texts in the network request 120, or major texts in the network request 120, such as parameters of API information, server address information, and the like.

For example, the network request 120 includes API information, parameters xxx-xxx-xxx-xxx of the API information, address information 10.62.231.143:443 of a server, a text length 2433 of the network request 120, and a request body {“name”:“PLC-2”, “description”:“PLC-2 DESCR”,“assetType”:“VMWARE_VIRTUAL”} of the network request 120. In addition to converting the API information into a predetermined serial number (for example, “1”) as above, the method includes replacing, in other information, an individual alphabet with “a”, an individual number with “n”, consecutive alphabets with “a+”, and consecutive numbers with “n+”. Consequently, through the above rule, the network request 120 is processed as 1, a+−a+−a+−a+, n+.n+.n+.n+:n+, n+, {“a+”: “a+−n”, “a+”: “a+−na+”, “a+”: “a+_a+”}. It would be appreciated that, since the text length is used to indicate a size of a request, each number in the text length may be directly replaced with “n”.

In the examples described above and in other embodiments, the present disclosure can prune the structure and the size of the network request 120 and further can simplify the subsequent detection process. Moreover, the model training system 260 can prune the text of each normal network request 250 in the same manner, such that the classification model 140 can be trained more quickly and more precisely.

In some embodiments, feature data of the network request 120 may be vectorized. For example, feature data of the network request 120 pruned in the manner described above may be vectorized. Alternatively or additionally, the text of the network request 120 may be directly vectorized as feature data. Furthermore, vectorization is preferably executed using Term Frequency-Inverse Document Frequency (TF-IDF). Alternatively, vectorization may also be executed using a shallow neural network, such as word2vec, or in other manners.

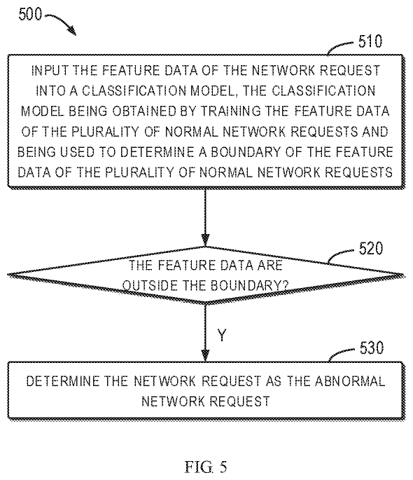

At 430, the computing device 110 may detect whether the feature data of the network request 120 falls out of a range defined by feature data of a plurality of normal network requests 250. If yes, the process moves to 440. At 440, the computing device 110 may determine the network request 120 as an abnormal network request. Reference will be made to FIG. 5 hereinafter to describe the specific embodiments of detection.

FIG. 5 illustrates a process or method 500 for detecting an abnormal network request according to embodiments of the present disclosure. In some embodiments, the method 500 may be implemented in a device as shown in FIG. 6. For example, the method 500 may be implemented in the computing device 110 as shown in FIG. 1, FIG. 2 or FIG. 3. Now, reference will be made to FIGS. 2 and 3 to describe the process or method 500 of detecting an abnormal network request according to the embodiments of the present disclosure, as shown in FIG. 5. For ease of understanding, the specific data as will be mentioned below are provided merely as an example, without suggesting any limitation to the protection scope of the present disclosure.

At 510, the computing device 110 may input the feature data of the network request 120 into the classification model 140. As aforementioned, the classification model 140 is obtained by training feature data of a plurality of normal network requests, and is used to determine a boundary of feature data of the plurality of normal network requests 250. When the classification model 140 is a one class support vector machine, the one class support vector machine may use the plurality of normal network requests 250 as samples, so as to determine a decision boundary or hyperplane of the samples, i.e., the above boundary.

At 520, the computing device 110 may compare the feature data of the network request 120 with the boundary. If the feature data are located outside the boundary, the process moves to 530. At 530, the computing device 110 determines the network request 120 as the abnormal network request.

In some embodiments, when extracting feature data from the network request 120, the computing device 110 may convert API information of the network request 120 into a first API symbol, and convert API information of the preceding network request having the same IP address as the network request 120 into a second API symbol. Thereafter, the computing device 110 may combine the first API symbol and the second API symbol as a part of the feature data. For example, the API information of the preceding network request and the API information of the network request 120 may be represented as “3, 1”. Alternatively or additionally, the API information of the preceding two network requests, the API information of the preceding network request and the API information of the network request 120 may be represented as “6, 3, 1”.

In some embodiments, when it is determined that the feature data of the network request 120 fall out of the range as mentioned above, the computing device 100 may determine a plurality of combinations of multiple normal network requests 250 with the API information of the respective associated network requests. For example, combinations of three normal network requests with API information of respective associated network requests are “5, 2, 4”, “1, 4, 16” and “8, 3, 1”, respectively. Because the feature data “6, 3, 1” of the network request 120 is not included in the above combinations, the network request 120 is determined as an abnormal network request. If an API combination not included occurs, the vector having undergone feature engineering processing deviates from the boundary of the support vector machine, thereby implementing the function of detecting abnormality. In this way, some simple detection algorithms may be built. For example, if it is found that neither of the network request 120 and the associated network request includes API invoking information of “login”, it is indicated that the network request 120 is probably an abnormal request. As a result, detection can be completed more quickly.

In addition, as shown in FIG. 3 and the above description, the computing device 110 may send the abnormal request 360 to a further server 330, such that the further server 330 may generate a response to the abnormal network request 360, based on the type of the access operation of the abnormal request 360. For example, the vectorized feature data of a plurality of normal network requests 250 may be clustered in advance, and a responding manner to each type of request may be determined. Upon receiving an abnormal request 360, the further server 330 performs distance calculation (for example, Euclidean distance) on the vectorized feature data of the abnormal request 360 and the plurality of clustered points. When the clustered point closest to the vectorized feature data of the abnormal request 360, a fake response may be made to the hacker initiating the abnormal request 360 according to the responding manner corresponding to the clustered point. In this way, the method may attract the hacker to continue attacking the further server 330. As such, the method not only protects the server 320 effectively, but also collects sufficient abnormal requests 360 as samples, for further analysis.

Through the above process, it is possible to detect whether the network request is abnormal based on the text information of a network request. The present disclosure not only detects validity of text content in a network request, but also detects validity of an API invoking sequence of a network request. In addition, the present disclosure utilizes textual content of a plurality of normal network requests to train a classification model, such as a one class support vector machine, and utilizes the boundary of the one class support vector to identify abnormal network requests. Moreover, the present disclosure further provides an isolated server, which can collect more abnormal network requests when ensuring security, to enrich sample resources of abnormal network requests.

FIG. 6 illustrates a schematic block diagram of an example device 600 that may be used to implement embodiments of the present disclosure. As shown, the device 600 includes a central processing unit (CPU) 601 which may perform various appropriate acts and processing, based on computer program instructions stored in a read-only memory (ROM) 602 or the computer program instructions loaded from a storage unit 608 to a random access memory (RAM) 603. The RAM 603 may also store all kinds of programs and data required by operating the storage device 600. The CPU 601, the ROM 602, and the RAM 603 are connected to each other via a bus 604, to which an input/output (I/O) interface 605 is also connected.

A plurality of components in the device 600 are connected to the I/O interface 605, including: an input unit 606 such as a keyboard, a mouse, and the like; an output unit 607 including various kinds of displays and a loudspeaker, etc.; a storage unit 608 including a magnetic disk, an optical disk, and etc.; a communication unit 609 including a network card, a modem, and a wireless communication transceiver, etc. The communication unit 609 allows the device 600 to exchange information/data with other devices through a computer network such as the Internet and/or various kinds of telecommunications networks.

Various processes and processing described above, e.g., the methods 400 and/or 500 may be executed by the processing unit 601. For example, in some embodiments, the methods 400 and/or 500 may be implemented as a computer software program that is tangibly included in a machine readable medium, e.g., the storage unit 608. In some embodiments, part or all of the computer programs may be loaded and/or mounted onto the device 600 via ROM 602 and/or communication unit 609. When the computer programs are loaded to the RAM 603 and executed by the CPU 601, one or more steps of the methods 400 and/or 500 as described above may be executed.

The present disclosure may be a method, a device, a system, and/or a computer program product. The computer program product may include a computer readable storage medium loaded with computer-readable program instructions thereon for executing various aspects of the present disclosure.

The computer readable storage medium may be a tangible device capable of holding and storing instructions used by an instruction execution device. The computer readable storage medium may be, but is not limited to, for example, electronic storage devices, magnetic storage devices, optical storage devices, electromagnetic storage devices, semiconductor storage devices, or any random appropriate combination thereof. More specific examples (non-exhaustive list) of the computer readable storage medium includes: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as a punched card storing instructions or an emboss within a groove, and any random suitable combination thereof. A computer readable storage medium used herein is not interpreted as a transitory signals per se, such as radio waves or other freely propagated electromagnetic waves, electromagnetic waves propagated through a waveguide or other transmission medium (e.g., optical pulses passing through fiber-optic cables), or electrical signals transmitted through electric wires.

The computer readable program instructions described herein may be downloaded from a computer readable storage medium to various computing/processing devices, or to external computers or external storage devices via a network, for example, the Internet, a local area network, a wide area network and/or a wireless network. The network may include copper transmission cables, optical fiber transmission, wireless transmission, routers, firewalls, switches, gateway computers and/or edge servers. The network adapter or network interface in each computing/processing device receives computer readable program instructions from the network and forwards the computer readable program instructions for storage in a computer readable storage medium of each computing/processing device.

Computer readable program instructions for executing the operations of the present disclosure may be assembly instructions, instructions of instruction set architecture (ISA), machine instructions, machine dependent instructions, microcode, firmware instructions, state setting data, or either source code or destination code written by any combination of one or more programming languages including object oriented programming languages, such as Smalltalk, C++ or the like, and conventional procedural programming languages, such as the “C” programming language or similar programming languages. The computer-readable program instructions may be completely or partially executed on the user computer, or executed as an independent software package, or executed partially on the user computer and partially on the remote computer, or completely executed on the remote computer or the server. In the case where a remote computer is involved, the remote computer may be connected to the user computer by any type of networks, including local area network (LAN) or wide area network (WAN), or connected to an external computer (such as via Internet provided by the Internet service provider). In some embodiments, the electronic circuit is customized by using the state information of the computer-readable program instructions. The electronic circuit may be a programmable logic circuit, a field programmable gate array (FPGA) or a programmable logic array (PLA) for example. The electronic circuit may execute computer-readable program instructions to implement various aspects of the present disclosure.

Various aspects of the present disclosure are described in reference with the flow chart and/or block diagrams of method, apparatus (systems), and computer program product according to embodiments of the present disclosure. It will be understood that each block in the flow chart and/or block diagrams, and any combinations of various blocks thereof may be implemented by computer readable program instructions.

The computer-readable program instructions may be provided to the processing unit of a general purpose computer, a dedicated computer or other programmable data processing devices to generate a machine, causing the instructions, when executed by the processing unit of the computer or other programmable data processing devices, to generate a device for implementing the functions/actions specified in one or more blocks of the flow chart and/or block diagram. The computer-readable program instructions may also be stored in the computer-readable storage medium. These instructions enable the computer, the programmable data processing device and/or other devices to operate in a particular way, such that the computer-readable medium storing instructions may comprise a manufactured article that includes instructions for implementing various aspects of the functions/actions specified in one or more blocks of the flow chart and/or block diagram.

The computer readable program instructions may also be loaded into computers, other programmable data processing devices, or other devices, so as to execute a series of operational steps on the computer, other programmable data processing devices or other devices to generate a computer implemented process. Therefore, the instructions executed on the computer, other programmable data processing devices, or other device may realize the functions/actions specified in one or more blocks of the flow chart and/or block diagram.

The accompanying flow chart and block diagram present possible architecture, functions and operations realized by the system, method and computer program product according to a plurality of embodiments of the present disclosure. At this point, each block in the flow chart or block diagram may represent a module, a program segment, or a portion of the instruction. The module, the program segment or the portion of the instruction includes one or more executable instructions for implementing specified logic functions. In some alternative implementations, the function indicated in the block may also occur in an order different from the one represented in the drawings. For example, two consecutive blocks actually may be executed in parallel, and sometimes they may also be executed in a reverse order depending on the involved functions. It should also be noted that each block in the block diagram and/or flow chart, and any combinations of the blocks thereof may be implemented by a dedicated hardware-based system for implementing specified functions or actions, or a combination of the dedicated hardware and the computer instructions.

Various embodiments of the present disclosure have been described above, and the above explanation is illustrative rather than exhaustive and is not limited to the disclosed embodiments. Without departing from the scope and spirit of each explained embodiment, many alterations and modifications are obvious for those ordinary skilled in the art. The selection of terms in the text aims to best explain principle, actual application or technical improvement in the market of each embodiment or make each embodiment disclosed in the text comprehensible for those ordinary skilled in the art.

1. A method for detecting abnormal network requests, comprising:
obtaining a network request for accessing a server;
extracting feature data from the network request, the feature data characterizing an access operation of the network request to the server; and
in response to the feature data falling out of a range defined by feature data of a plurality of normal network requests, determining that the network request as the is an abnormal network request.

2. The method of claim 1, wherein extracting the feature data from the network request comprises:
processing the network request using predetermined symbols to obtain a processed network request; and
obtaining the feature data from the processed network request.

3. The method of claim 2, wherein processing the network request with the predetermined symbols comprises:
replacing an alphabet in the network request with a first symbol; and
replacing a number in the network request with a second symbol.

4. The method of claim 2, wherein processing the network request with the predetermined symbols comprises:
replacing an individual alphabet in the network request with a third symbol;
replacing an individual number in the network request with a fourth symbol;
replacing consecutive alphabets in the network request with a fifth symbol; and
replacing consecutive numbers in the network request with a sixth symbol.

5. The method of claim 2, wherein extracting the feature data from the network request further comprises:
vectorizing the feature data.

6. The method of claim 1, wherein, in response to the feature data falling out of the range defined by the feature data of the plurality of normal network requests, determining that the network request is an abnormal network request comprises:
inputting the feature data of the network request into a classification model, the classification model being obtained by training the feature data of the plurality of normal network requests and being used to determine a boundary of the feature data of the plurality of normal network requests; and
in response to the feature data of the network request being outside the boundary, determining that the network request is an abnormal network request.

7. The method of claim 1, wherein obtaining the network request for accessing the server comprises:
determining an Internet Protocol (IP) address of the network request; and
obtaining, from the server, an associated network request having the IP address.

8. The method of claim 7, wherein extracting the feature data from the network request comprises:
converting Application Program Interface (API) information of the network request into a first API symbol; and
converting the API information of the associated network request into a second API symbol,
wherein the feature data comprises the first API symbol and the second API symbol.

9. The method of claim 8, wherein, in response to the feature data falling out of the range, determining the network request is an abnormal network request comprises:
determining a plurality of combinations of the plurality of normal network requests with API information of respective associated network requests; and
in response to the at least a part of the feature data being absent in the plurality of combinations, determining that the network request is an abnormal network request.

10. The method of claim 1, further comprising:
sending the abnormal network request to a further server independent of the server.

11. The method of claim 1, wherein the access operation includes at least one of selected from a group consisting of:
an Application Program Interface (API) information of the network request;
parameters of the API information;
address information of the server;
a text length of the network request; and
a request body of the network request.

12. An electronic device, comprising:
at least one processing unit; and
at least one memory coupled to the at least one processing unit and storing machine-executable instructions, the instructions, when executed by the at least one processing unit, causing the device to perform a method, the method comprising:
obtaining a network request for accessing a server;
extracting feature data from the network request, the feature data characterizing an access operation of the network request to the server; and
in response to the feature data falling out of a range defined by feature data of a plurality of normal network requests, determining that the network request is an abnormal network request.

13. The device of claim 12, wherein extracting the feature data from the network request comprises:
processing the network request using predetermined symbols to obtain a processed network request; and
obtaining the feature data from the processed network request.

14. The device of claim 13, wherein processing the network request with the predetermined symbols comprises:
replacing alphabets in the network request with a first symbol; and
replacing numbers in the network request with a second symbol.

15. The device of claim 13, wherein processing the network request with the predetermined symbols comprises:
replacing an individual alphabet in the network request with a third symbol;
replacing an individual number in the network request with a fourth symbol;
replacing consecutive alphabets in the network request with a fifth symbol; and
replacing consecutive numbers in the network request with a sixth symbol.

16. The device of claim 13, wherein extracting the feature data from the network request further comprises:
vectorizing the feature data.

17. The device of claim 12, wherein, in response to the feature data falling out of the range defined by the feature data of the plurality of normal network requests, determining that the network request is an abnormal network request comprises:
inputting the feature data of the network request into a classification model, the classification model being obtained by training the feature data of the plurality of normal network requests and being used to determine a boundary of the feature data of the plurality of normal network requests; and
in response to the feature data of the network request being outside the boundary, determining that the network request is an abnormal network request.

18. The device of claim 12, wherein obtaining the network request for accessing the server comprises:
determining an Internet Protocol (IP) address of the network request; and
obtaining, from the server, an associated network request having the IP address.

19. The device of claim 18, wherein extracting the feature data from the network request comprises:
converting Application Program Interface (API) information of the network request into a first API symbol;
converting API information of the associated network request into a second API symbol; and
wherein the feature data comprises the first API symbol and the second API symbol.

20. (canceled)

21. (canceled)

22. (canceled)

23. A computer program product tangibly stored on a non-transient computer readable medium and comprising machine executable instructions, which, when executed, cause a machine to perform a method, the method comprising:
obtaining a network request for accessing a server;
extracting feature data from the network request, the feature data characterizing an access operation of the network request to the server; and
in response to the feature data falling out of a range defined by feature data of a plurality of normal network requests, determining that the network request is an abnormal network request.
